(19) United States
(12) Patent Application Publication
(10) Pub. No.: US 2007/0116222 A1
(43) Pub. Date: May 24, 2007

(54) Method and apparatus for activity selection during on-hold

(76) Inventor: Eric Thelen, Aachen (DE)

Correspondence Address: PHILIPS INTELLECTUAL PROPERTY & STANDARDS, P.O. BOX 3001, BRIARCLIFF MANOR, NY, 10510, US

(21) Appl. No.: 10/558,086

(22) PCT Filed: May 18, 2004
(86) PCT No.: PCT/IB04/50730

§ 371 Date: Oct. 30, 2006

(30) Foreign Application Priority Data
May 26, 2003 (EP) 03101520.9

(51) Int. Cl. H04M 1/00

(52) U.S. Cl. 379/162

(57) ABSTRACT

A description is given of a method of maintaining a connection request of a calling subscriber Station (RT1), in which a connection request relating to a target subscriber Station (ZTI1, ZT2) is indicated by the calling subscriber station (RT1). The calling subscriber station (RT 1), with the connection request being maintained, is connected to a start information source (SIQ) if a connection corresponding to the connection request is not possible. The start information source (SIQ) comprises an information element to which an address (ADR ZIQ) of a target information source (ZIQ) is assigned. An information element of the start information source (SIQ) is output in voice form to the calling subscriber Station (RT 1). Based an selection information (AI) entered an the calling subscriber Station (RT1) by means of a user input, an output information element is selected. The calling subscriber station (RT1), based an the address (ADR ZIQ) assigned to the selected information element, is connected to a target information source (ZIQ).

The invention relates to a method of maintaining a connection request of a calling subscriber station, to a corresponding communication control device, and to a corresponding system for maintaining a connection request.

In order to maintain a connection request of a calling subscriber station, it has long been known to keep the calling subscriber station in what is referred to as a “hold loop”, for example if the called subscriber station (target subscriber station) is busy. As soon as the target subscriber station is free, the hold loop is broken and the calling subscriber station is connected to the target subscriber station. During the hold loop, an attempt is generally made to entertain the calling subscriber by playing a piece of hold loop music. However, this hold loop music is usually not of interest to the calling subscriber and not attractive enough to keep the calling subscriber in the hold loop until the target subscriber station becomes free. Therefore, the connection request is often terminated by the calling subscriber shortly after the start of the hold loop music. This is particularly disadvantageous for business target subscribers, since every calling subscriber is a potential customer. Therefore, business target subscribers in particular would like to keep calling subscribers in a hold loop when the target subscriber station is busy until the target subscriber station becomes free. Despite great efforts to develop this, it has not been possible to date to fulfill this desire that has been known over the years. A significant reason for this is that the known telephone connections do not allow a calling subscriber to be entertained in a pleasant manner in a hold loop. For instance, it is not possible to transmit music of hi-fi quality over a telephone line, and thus to keep a calling subscriber in the hold loop long enough by using an unattractive form of entertainment.

Independently of the maintenance of a connection request by means of a hold loop as described above, dialog systems are known which communicate with a user by means of voice recognition and voice output methods. These are voice-controlled automated systems which are often referred to as voice portals. One example can be seen in automated call-answering and information systems, as have meanwhile been used for example in some large companies and offices. Whereas when using a hold loop the aim is to keep a caller on the line for as long as possible, the aim of such a dialog system is to provide the information that the caller wants in as fast and specific a manner as possible, or else to connect to a location responsible for the specific requirements of the caller. Hierarchical menu structures usually form the IT background for such dialog systems, by means of which menu structures the caller can navigate to the desired information by inputting corresponding selection commands using the keypad of his subscriber station or by voice. It is characteristic of these dialog systems that the information offered relates to a company or an office, and that all the information offered is stored in the same central storage device which forms an important part of the dialog system. In this case, a caller always remains connected with the same dialog system during navigation within the hierarchical menu structure. Although this form of dialog systems is stable and expedient, it only allows restricted access to information in terms of both content and location.

It is an object of the invention to specify a method of maintaining a connection request of a calling subscriber station, which method makes it possible for a calling subscriber, with the connection request being maintained, to have varied access to information in a convenient manner.

This object is achieved by a method of the type mentioned above, in which a connection request relating to a target subscriber station is indicated by the calling subscriber station, in which the calling subscriber station, with the connection request being maintained, is connected to a start information source if a connection corresponding to the connection request is not possible, in which the start information source comprises an information element to which an address of a target information source is assigned, in which an information element of the start information source is output in voice form to the calling subscriber station, in which, based on selection information entered on the calling subscriber station by means of a user input, an output information element is selected, and in which the calling subscriber station, based on the address assigned to the selected information element, is connected to a target information source.

The calling subscriber station and the target subscriber station may in this case in particular be a fixed network telephone or a mobile telephone. In particular, the target subscriber station may also form part of a larger communication system or part of a call center system. The term “target subscriber station” then also covers a group of target subscriber stations if the connection request of the calling subscriber station does not relate to a specific target subscriber station but rather to a group of target subscriber stations. Frequently, in particular within the context of call center systems, a group of target subscriber stations is addressed specifically by a common target call number. It may remain unclear to the calling subscriber whether, by inputting a target call number, he is initiating a connection request to a specific target subscriber station or to a group of target subscriber stations.

The connection request preferably relates to a voice connection or telephone connection. The setup of a connection corresponding to the connection request is not possible, for example, when the target subscriber station cannot be reached. The reasons for it not being possible to reach the target subscriber station may be, in particular, that:

the target subscriber station is already busy, the target subscriber station is configured as a mobile station and at that instant is not registered in any mobile radio system, or

on expiry of a given period of time following the initiation of the connection request, the connection request is not correspondingly answered at the target subscriber station, in particular the target subscriber does not pick up or rejects the connection request.

In order to maintain the connection request, it can be indicated to the target subscriber station or to a communication control device connected to the target subscriber station, continuously or at fixed or variable time intervals, that the calling subscriber station wishes to set up a connection to the target subscriber station. If, for example, a calling subscriber, by inputting a target call number, is connected to the communication control device of a call center system and is informed there that the target subscriber station is busy, then a connection request entry can be stored in the communication control device, which connection request entry continuously indicates internally to the communication control device that there is a connection request of a calling subscriber station which relates to the target subscriber station.

The term “start information source” comprises in particular stored information in any desired formats, storage devices on which this information is stored or information servers which enable access to this information. The start information source may comprise information elements in any desired format, such as text elements or audio elements for example. In each case the address of a target information source is assigned to information elements that are given particular emphasis, so-called links, in order to refer to the target information source from the start information source. The particular emphasis on information elements that are output as voice can be realized by means of acoustic marking, for example an output with a higher volume, a different pitch or a short signal tone following the outputting of the information element. The calling subscriber can gain access to a large number of information sources worldwide in particular through the use of Internet pages or Internet servers as start information source.

The connection of the calling subscriber station to a start information source can be realized in various ways depending on the communication environment in which the invention is embedded. For example, a connection between calling subscriber station and start information source can be effected with or without involvement of a communication control device as mentioned above. The connection between calling subscriber station and start information source can be effected using one or more switching systems and/or routers. Depending on the communication protocol used, telephone numbers or Internet addresses, in particular IP addresses or so-called URLs (Uniform Resource Locators), can be used to address the start information source. A connection between calling subscriber station and start information source also comprises the case where information is loaded onto a communication control device by the start information source and from there is forwarded to the calling subscriber station or from there is downloaded to the calling subscriber station.

What has been described above in relation to the start information source also applies in the same way to the target information source in terms of addressing and content.

Preferably, the connection between calling subscriber station and start information source is different from the connection between calling subscriber station and target information source. In particular, different communication infrastructure devices, such as switching devices or routers, are used to realize these two connections. According to a particularly preferred embodiment of the invention, the connections between the calling subscriber station and the information sources are also based at least partially on a voice connection. This makes it possible for the invention to be implemented by an existing and widespread fixed network telephone infrastructure and corresponding fixed network telephones.

The information elements of the start information source can be output to the calling subscriber station in addition to other information based on the start information source. For this purpose, the information elements present as text may be converted into voice, in particular synthesized voice, or else the information elements present as audio information may be played back. The conversion of the text elements into voice may in this case take place at the start information source, by the start information source, at the calling subscriber station or by the calling subscriber station, by a central device of a communication network or by a communication control device.

In order to select an acoustically emphasized information element by means of a user input, the calling subscriber can repeat for example the information element, output as voice, itself, or can speak a selection command word, such as “connect” or “link” for example, within a predefined period of time following the outputting of the information element, or can actuate a corresponding actuation element on the calling subscriber station within a predefined period of time following the outputting of the information element.

Preferably, the selection information entered by means of a voice input is interpreted by a voice recognition device and processed further in order to select an output information element or the address of a target information source that is assigned to this information element. It is thereby possible to link a data network that comprises information sources to a voice communication network that comprises subscriber stations. In this way, calling subscribers of a voice communication network can gain access to information sources of a data network. The interface or transition between voice communication network and data network is in this case realized by the voice recognition device for the parts of data that do not exist in audio form. The voice recognition device can be implemented on the calling subscriber station or by the calling subscriber station, on the target subscriber station or by the target subscriber station, in a central device of the communication network used or in a communication control device.

As soon as the calling subscriber station is connected to the target information source, which is determined by the address assigned to the selected information element, the method can preferably be continued in that the target information source becomes the new start information source, from which the calling subscriber can be referred to a further target information source, etc.

The invention achieves that, if the target subscriber cannot be reached, a calling subscriber is “kept on the line” for a long time on account of the fact that information is offered which he finds interesting. The more attractive and varied the information that is offered, the greater are the chances that the calling subscriber will not hang up and will thus maintain his connection request until the target subscriber station can be reached. In order to be able to offer a calling subscriber interesting information until the target subscriber can be reached, the invention teaches in particular that the calling subscriber station be connected to various information sources in accordance with the desires of the calling subscriber, which information sources may in each case contain addresses of other information sources in order to be able to connect the calling subscriber station successively to one information source after another. As a result, it is possible for the calling subscriber to “surf” informatively from one information source to another information source, and thus the likelihood is increased that the connection request will be maintained for a long period of time.

Preferably, the calling subscriber station is connected to the target subscriber station when a connection corresponding to the connection request is possible. For this purpose, a check can automatically be made, continuously or at fixed or variable time intervals, as to whether the target subscriber station can be reached. As soon as this check ascertains that the target subscriber station can be reached, the calling subscriber station can automatically be connected to the target subscriber station. If a number of calling subscriber stations wish to connect to a target subscriber station at the same time, this check can be linked with a preferred connection of one of the calling subscriber stations to the target subscriber station. This preferred allocation of the connection to the target subscriber station may depend, for example, on the duration of the maintenance of the connection request by the individual subscriber stations, on the identity of the calling subscriber stations or of the calling subscriber, or on the information source to which the calling subscriber station is already connected. As a result, customers who have been waiting for a long time, important customers or sufficiently informed customers can be connected with preference to the target subscriber station.

A particularly preferred embodiment provides that the calling subscriber station is connected to the target subscriber station when, in addition to the possibility of a connection corresponding to the connection request, at least one other criterion is met. The other criterion may be, for example, the consent of the calling subscriber. For this purpose—as soon as there is the possibility of a connection to the subscriber station that corresponds to the connection request—an enquiry can be made back to the calling subscriber to ascertain whether he would now like a connection to the target subscriber station or would prefer first to remain connected a little longer to the information source.

Preferably, the calling subscriber station, after termination of the connection to the target subscriber station, is automatically or at the request of the calling subscriber connected again to the information source to which it was connected prior to the connection to the target subscriber station. As a result, a customer can further investigate the offer of information covered while waiting for the connection to the target subscriber station.

In order to be able to offer the calling subscriber selected information relating to his personal requirements, the start information source can automatically be selected as a function of the identity of the calling subscriber and/or of the identity of the calling subscriber station. Thus, the calling subscriber can immediately be offered a particularly interesting information source, for example based on a customer database in which the information source access history of earlier calls or the consumer history of the calling subscriber is stored.

By restricting access to information sources in terms of duration or type of information source as a function of the identity of the calling subscriber and/or of the identity of the calling subscriber station, the situation can be achieved that for example only exceptionally loyal customers are granted access to particularly attractive consumer offers or that for example only employees are granted access to confidential company information.

The fee for the connection to information sources and/or access to information sources may be levied at least partly on the calling subscriber as a function of the identity of the calling subscriber and/or of the identity of the calling subscriber station. As a result, preferred calling subscribers can access the offered information for example free of charge, whereas callers who are less important from the target subscriber's point of view must where appropriate pay further fees for the connection to information sources or access to specific selected information sources, in addition to the fees for the call. Depending on the configuration, the fees may be levied either in favor of the provider of the information source, in favor of the target subscriber or in favor of the operator of the communication network.

Preferably, the described start, access and fee-levying options can be set up or adjusted by the target subscriber or another person who has access to the communication control device.

A communication control device for maintaining a connection request of a calling subscriber station comprises a subscriber station interface for connecting the communication control device to subscriber stations, an information source interface for connecting the communication control device to a start information source and a target information source, where the start information source comprises an information element and an address of a target information source that is assigned to the information element, and a processor device which is configured such that a calling subscriber station indicating a desire to set up a connection relating to a target subscriber station, with the connection request being maintained, is connected to a start information source if a connection corresponding to the connection request is not possible, such that an information element of the start information source is output in voice form to the calling subscriber station, such that selection information, entered on the calling subscriber station by means of a user input, for selecting an output information element is converted into an address of a target information source that is assigned to the selected information element, and such that the calling subscriber station is connected to a target information source on the basis of the address of a target information source that is assigned to the selected information element.

The communication control device, which preferably comprises one or more switching devices and/or routers, can in this case also be realized by a communication system, comprise a communication system or form part of a communication system. Communication systems are also frequently referred to as communication servers, communication platforms or private branch exchanges (PBXs).

The invention also comprises a system for maintaining a connection request of a calling subscriber station, having a calling subscriber station, having a start information source and a target information source, where the start information source comprises an information element and an address of a target information source that is assigned to the information element, and having a communication control device as described above.

The communication control device and the system for maintaining a connection request can be developed in accordance with the dependent claims of the method claim.

The invention will be further described with reference to examples of embodiments shown in the drawings to which, however, the invention is not restricted.

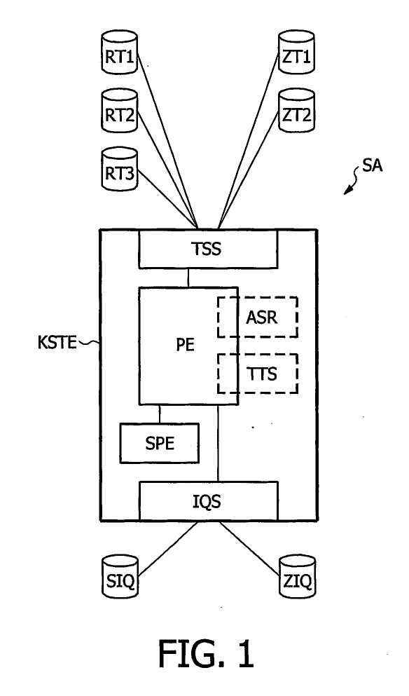

FIG. 1 shows a simplified diagram of a system architecture for maintaining a connection request of a calling subscriber station.

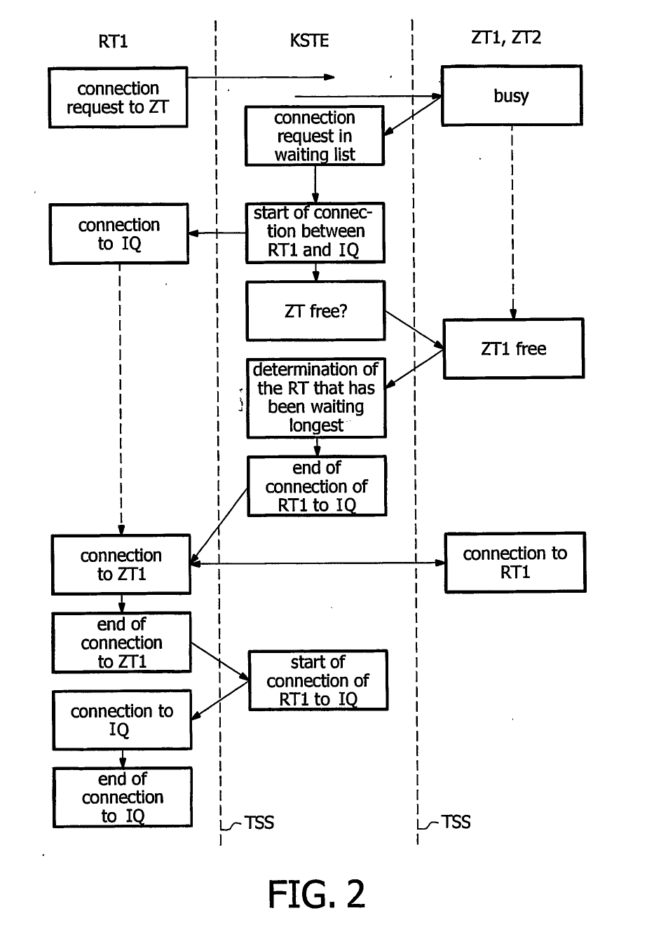

FIG. 2 shows a flowchart of a method of maintaining a connection request of a calling subscriber station.

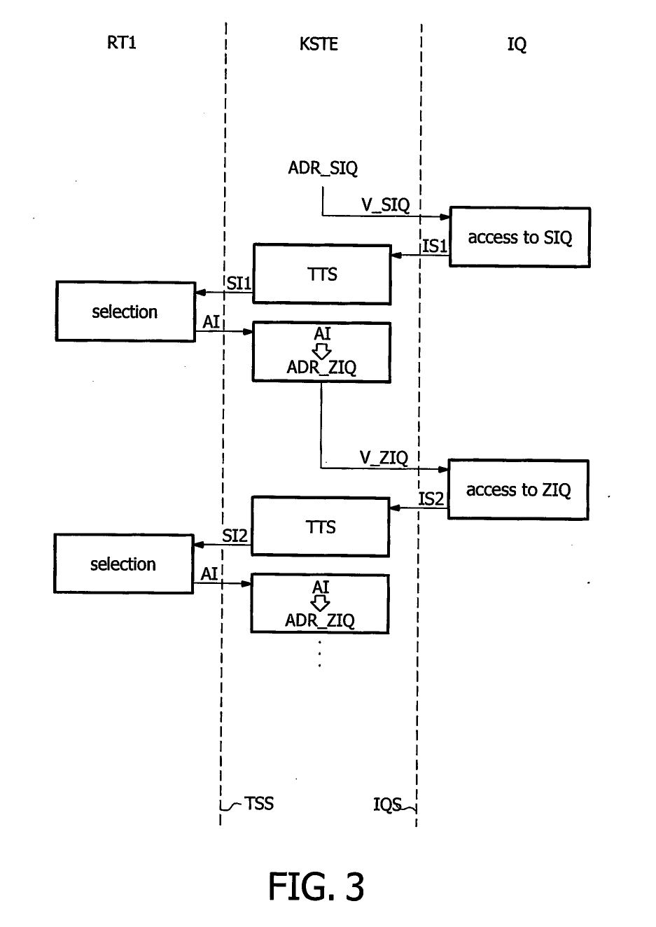

FIG. 3 shows a flowchart of a method for access to information sources by a calling subscriber station.

For the sake of clarity, only the essential components of the hardware configuration of the system are shown in FIG. 1. It is obvious that this system also has all other components which usually belong to communication networks, such as suitable connecting lines, switching systems or routers.

FIG. 1 shows, as part of a system SA for maintaining a connection request of a calling subscriber station RT1, a communication control device KSTE, calling subscriber stations RT1, RT2, RT3, target subscriber stations ZT1, ZT2, a start information source SIQ and a target information source ZIQ. The subscriber stations RT1, RT2, RT3, ZT1, ZT2 are conventional fixed network telephones which are connected to the communication control device KSTE via a conventional fixed telephone network. The information sources SIQ, ZIQ in each case consist of an Internet server on which Internet pages are stored. The Internet servers are connected to the communication control device KSTE via the Internet.

The communication control device KSTE has a fixed network telephone interface TSS for connecting the communication control device KSTE to subscriber stations RT1, RT2, RT3, ZT1, ZT2, and an Internet interface IQS for connecting the communication control device KSTE to information sources SIQ, ZIQ.

A program-controlled processor device PE forms the core of the communication control device KSTE, which processor device PE controls the progress of the method executed by the communication control device KSTE. Program data and/or subscriber data, such as subscriber call numbers, subscriber consumer histories or information source access histories of individual subscribers, are stored in a storage device SPE which can be accessed by the processor device PE. Settings of the communication control device KSTE, which have been carried out by the target subscriber or the administrator of the communication control device KSTE, may also be stored in the storage device SPE.

A voice recognition device ASR and a text-to-voice converter TTS are formed by the processor device PE and other circuit arrangements specifically provided for this purpose.

With reference to FIG. 2, the running of a method will now be described by way of example, in which a calling subscriber station RT1, with a connection request being maintained, is connected to Internet servers because the target subscriber stations ZT1, ZT2, to which the connection request relates, are busy.

FIG. 2 shows, to the left of the left-hand dashed line which represents the fixed network telephone interface TSS, the sequence on the calling subscriber station RT1; to the right of the right-hand dashed line which likewise represents the fixed network telephone interface TSS, the sequence on the target subscriber stations ZT1, ZT2; and between the two dashed lined the sequence on the communication control device KSTE.

First, the calling subscriber station RT1 signals a connection request to the communication control device KSTE, by inputting the call number “xxx”, said connection request relating to a fixed network telephone connection to a target subscriber station ZT assigned to this call number. In this example, two target subscriber stations ZT1, ZT2 are assigned to the call number “xxx”, which two target subscriber stations ZT1, ZT2 are busy at this moment in time. In order to maintain the connection request of the calling subscriber station RT1, the connection request is added to a waiting list in which other subscriber stations that are calling the target subscriber stations ZT1, ZT2 have already been entered.

On the basis of the call number transmitted to the communication control device KSTE, the calling subscriber station is asked, from a database stored in the communication control device KSTE, to which information source the calling subscriber station RT1 was last connected with a connection request relating to the target subscriber stations ZT1, ZT2 being maintained. The Internet address of this most recently used information source is then used as a start Internet address ADR_SIQ of a start information source SIQ, to which the calling subscriber station RT1 is connected. The fees for the connection to information sources IQ and for access to information sources IQ are in this case borne by the target subscriber. The further development of access to information sources IQ making reference to one another is described below with reference to FIG. 3.

While the calling subscriber station RT1 is now connected to information sources with the connection request being maintained, a check is made at fixed intervals to ascertain whether one of the two target subscriber stations ZT1, ZT2 is free. As soon as one of the two target subscriber stations ZT1 is free, on the basis of the waiting list it is determined which of the subscriber stations RT calling the target subscriber stations ZT1, ZT2 has waited the longest for a connection to one of the two target subscriber stations ZT1, ZT2. If the calling subscriber station RT1 is the calling subscriber station that has been waiting the longest, it is indicated to the calling subscriber that a connection to a target subscriber station ZT1 is possible. If the calling subscriber now, for example, prefers to remain connected a while longer to information sources IQ, then following a user input to this effect the corresponding subscriber station RT1 is re-entered in the waiting list and the possibility of a connection to a target subscriber station ZT1 is indicated to the next calling subscriber station in the waiting list. However, if, for example, the calling subscriber accepts the offer of a connection to a target subscriber station ZT1 by means of a user input to this effect on the calling subscriber station RT1, the connection to the information sources, that is to say the “surfing”, is interrupted and the calling subscriber station RT1 is connected to the target subscriber station ZT1.

When the conversation between the calling subscriber station RT1 and the target subscriber station ZT1 has ended, the calling subscriber is again offered a connection to the information source to which he was connected prior to the connection to the target subscriber station. If the calling subscriber accepts the offer, the calling subscriber station RT1 is again connected to the corresponding information source. From this information source, the calling subscriber can then be connected again to other information sources IQ. In order in this case to limit the connection fees levied on the target subscriber, either the duration of the further connections to information sources IQ can be restricted, or the fees which arise for the further connections to information sources or further access to information sources can be levied on the calling subscriber station RT1. This is preferably indicated to the calling subscriber beforehand. The method thus ends by the calling subscriber terminating the connection to information sources IQ by means of a user input to this effect on the calling subscriber station RT1.

With reference to FIG. 3, method steps of a connection of the calling subscriber station RT1 to information sources SIQ, ZIQ will now be described in more detail. The method begins with the above-described determination of the Internet address ADR_SIQ of the information source which was accessed by the calling subscriber station RT1 when last attempting to be connected to a target subscriber station. FIG. 3 shows, to the left of the left-hand dashed line which represents the fixed network telephone interface TSS, the sequence on the calling subscriber station RT1; to the right of the right-hand dashed line which represents the Internet interface IQS, the sequence on the information sources SIQ, ZIQ; and between the two dashed lines, as the core of the system, the sequence on the communication control device KSTE.

Based on the determined Internet address ADR_SIQ, a connection V_SIQ is produced between the corresponding information source as start information source SIQ and the calling subscriber station RT1. For this purpose, a conventional Internet page IS1 is loaded by an Internet server as start information source onto the communication control device KSTE. The Internet page in this case comprises, for example, the text “Would you like to hear today's news?”. The text information element “news” is configured as a link, to which the Internet address ADR_ZIQ of a target information source is assigned. By means of the text-to-voice converter TTS, the text “Would you like to hear today's news?” is converted into synthesized voice, which transmits corresponding voice information SI1 to the calling subscriber station RT1 and outputs it on the calling subscriber station RT1. When outputting the voice information SI1 on the calling subscriber station RT1, in order to identify the link “news” immediately after the word “news” has been output, a signal tone is output in order to indicate the link to the calling subscriber. To select the link “news”, the calling subscriber inputs corresponding selection information AI on the calling subscriber station RT1, by repeating the word “news”.

Based on the Internet address ADR_ZIQ, which is assigned to the selected text information element “news”, a connection V_ZIQ is then produced between the calling subscriber station RT1 and the corresponding information source as target information source ZIQ. Once again, a conventional Internet page IS2 is loaded by an Internet server onto the communication control device KSTE. The Internet page now comprises the text “Are you interested in sports news or general news?”, where the text information elements “sports news” and “general news” are configured as links to which the Internet addresses of target information sources are assigned. By means of the text-to-voice converter TTS, the text “Are you interested in sports news or general news?” is again converted into synthesized voice, the corresponding voice information SI2 is transmitted to the calling subscriber station RT1 and is output on the calling subscriber station RT1, where the text information elements “sports news” and “general news” are again acoustically marked as links. To select the link “sports news”, the calling subscriber this time speaks the words “sports news” AI on the calling subscriber station RT1. Based on the Internet address ADR_ZIQ, which is assigned to the selected text information element “sports news”, the calling subscriber station RT1 is then connected to the corresponding information source as target information source, etc.

In this way, the calling subscriber can be connected time and time again to a large number of information sources and thus, despite the use of a fixed network telephone and while maintaining a connection request relating to a voice connection to a target subscriber station, gain access in a flexible manner to information that is embedded in a data network, such as the Internet.

Finally, it should be pointed out once again that the systems and methods shown in the figures and the description are merely examples of embodiments, which can be varied to a large extent by a person skilled in the art without departing from the scope of the invention. For instance, in the above-described examples of embodiments, the subscriber station interface was formed by a fixed network connection and the information source interface was formed by an Internet connection. However, these interfaces can likewise be based on other standardized or proprietary communication protocols. In addition, in the examples of embodiments, the connection of calling subscriber station to information source was made by an Internet page first being loaded onto a central communication control device, converted there into voice, and then transmitted to the calling subscriber station. The calling subscriber station can also be connected to the information source with the intermediate connection of conventional routers and/or switching devices, and the information elements of the information source can even be converted into voice at the information source or by the information source or be stored in voice form as audio data and directly transmitted by the information source to the calling subscriber station. In addition or as an alternative to forming the text-to-voice converter on the or by the information source, the voice recognition device for recognizing the selection information input as voice by the calling subscriber can also be formed on the or by the information source. It is also possible for the communication control device and at least the start information source to be designed as a single unit. Moreover, for the sake of completeness, it should be pointed out that the use of the indefinite article “a” or “an” is not ruled out, that the relevant features may also be present more than once, and that the use of the term “comprise” does not rule out the existence of other elements or steps.

1. A method of maintaining a connection request of a calling subscriber station (RT1),
in which a connection request relating to a target subscriber station (ZT1, ZT2) is indicated by the calling subscriber station (RT1),
in which the calling subscriber station (RT1), with the connection request being maintained, is connected to a start information source (SIQ) if a connection corresponding to the connection request is not possible,
in which the start information source (SIQ) comprises an information element to which an address (ADR_ZIQ) of a target information source (ZIQ) is assigned,
in which an information element of the start information source (SIQ) is output in voice form to the calling subscriber station (RT1),
in which, based on selection information (AI) entered on the calling subscriber station (RT1) by means of a user input, an output information element is selected, and
in which the calling subscriber station (RT1), based on the address (ADR_ZIQ) assigned to the selected information element, is connected to a target information source (ZIQ).

2. A method as claimed in claim 1, characterized in that the calling subscriber station (RT1) is connected to the target subscriber station (ZT1) when a connection corresponding to the connection request is possible.

3. A method as claimed in claim 2, characterized in that the calling subscriber station (RT1) is connected to the target subscriber station (ZT1) when, in addition to the possibility of a connection corresponding to the connection request, at least one other criterion is met.

4. A method as claimed in claim 2, characterized in that the calling subscriber station (RT1), following the termination of the connection to the target subscriber station (ZT1), is again connected to the information source to which it was connected prior to the connection to the target subscriber station (ZT1).

5. A method as claimed in claim 1, characterized in that the user input comprises a voice input, and in that selection information (AI) entered by means of a voice input is interpreted using a voice recognition method.

6. A method as claimed in claim 1, characterized in that an information element of the start information source (SIQ) exists as a text information element and is converted into voice before being output to the calling subscriber station (RT1).

7. A method as claimed in claim 1, characterized in that the start information source (SIQ) is automatically selected as a function of the identity of the calling subscriber and/or of the identity of the calling subscriber station (RT1).

8. A method as claimed in claim 1, characterized in that access to information sources is restricted in terms of duration or type of information source as a function of the identity of the calling subscriber and/or of the identity of the calling subscriber station (RT1).

9. A method as claimed in claim 1, characterized in that a fee for the connection to information sources and/or access to information sources is levied at least partly on the calling subscriber as a function of the identity of the calling subscriber and/or of the identity of the calling subscriber station (RT1).

10. A communication control device (KSTE) for maintaining a connection request of a calling subscriber station (RT1), having a subscriber station interface (TSS) for connecting the communication control device (KSTE) to subscriber stations (RT1, RT2, RT3), having an information source interface (IQS) for connecting the communication control device (KSTE) to a start information source (SIQ) and a target information source (ZIQ), where the start information source (SIQ) comprises an information element and an address (ADR_ZIQ) of a target information source (ZIQ) that is assigned to the information element, and having a processor device (PE) which is configured:
such that a calling subscriber station (RT1) which is indicating a connection request relating to a target subscriber station (ZT1, ZT2), with the connection request being maintained, is connected to a start information source (SIQ) if a connection corresponding to the connection request is not possible,
such that an information element of the start information source (SIQ) is output in voice form to the calling subscriber station (RT1),
such that selection information (AI), entered on the calling subscriber station (RT1) by means of a user input, for selecting an output information element is converted into an address (ADR_ZIQ) of a target information source (ZIQ) that is assigned to the selected information element, and
such that the calling subscriber station (RT1), based on the address (ADR_ZIQ) of a target information source (ZIQ) that is assigned to the selected information element, is connected to a target information source (ZIQ).

11. A system (SA) for maintaining a connection request of a calling subscriber station (RT1), having a calling subscriber station (RT1, RT2, RT3), having a start information source (SIQ) and a target information source (ZIQ), where the start information source (SIQ) comprises an information element and an address (ADR_ZIQ) of a target information source (ZIQ) that is assigned to the information element, and having a communication control device (KSTE) as claimed in claim 10.
